(19) United States
(12) Patent Application Publication
(10) Pub. No.: US 2021/0293247 A1
(43) Pub. Date: Sep. 23, 2021

(54) AIR BLOWER AND STATIC PRESSURE EVALUATION APPARATUS

(71) Applicant: Panasonic Intellectual Property Management Co., Ltd, Osaka (JP)

(72) Inventors: Yuki UNO, Aichi (JP); Koki ANDO, Aichi (JP); Ayumi KONISHI, Aichi (JP)

(21) Appl. No.: 17/161,939

(22) Filed: Jan. 29, 2021

(30) Foreign Application Priority Data
Mar. 23, 2020 (JP) 2020-050513

(51) Int. Cl. F04D 27/00; F04D 25/06; F04D 25/08

(52) U.S. Cl. CPC F04D 27/004; H02P 6/06; F04D 25/08; F04D 25/06

(57) ABSTRACT

The air blower capable of exercising constant airflow rate control and a static pressure evaluation apparatus connectable to the air blower are provided, in which the air blower provides information for improving a duct shape and a duct path by calculating a static pressure in a duct connected to the air blower from a value of a current flowing through a brushless DC motor built in the air blower, a rotation speed of the brushless DC motor, a target airflow rate, and data on relations among these values; displaying at least one of a static pressure value and an evaluation, stored beforehand in accordance with a static pressure level, of the calculated static pressure; and, during installation of a ventilation fan, evaluating a duct resistance from the static pressure in the duct connected to the ventilation fan.

### BACKGROUND

### 1. Technical Field

The present disclosure relates to an air blower and a static pressure evaluation apparatus.

### 2. Description of Related Art

As described in Japanese Unexamined Patent Application Publication No. 2002-165477, as a method for controlling a ventilation fan capable of changing an airflow rate, there is a method of controlling an airflow rate to be constant, irrespective of a static pressure inside a duct. In a ventilation fan to which such control method is applied, even when a static pressure becomes higher under usual control and accordingly an actual airflow rate becomes smaller than a target airflow rate, as long as the static pressure falls within a range that allows constant airflow rate control, the ventilation fan can be operated at the target airflow rate by adjusting the output of the ventilation fan.

### SUMMARY

In a ventilation fan to which the above-mentioned conventional control method is applied, a static pressure range that allows constant airflow rate control is predetermined, and accordingly, under a static pressure exceeding the range, constant airflow rate control cannot be exercised. Furthermore, even in the case where a static pressure falls within the range that allows constant airflow rate control, when the static pressure is higher than necessary due to a duct condition, a larger amount of energy is consumed. However, it is not easy to directly evaluate a static pressure inside a duct for a ventilation fan, particularly on an installation site. In other words, it is difficult to evaluate whether an actually-installed ventilation fan is in a state capable of exercising constant airflow rate control.

Therefore, an object of the present disclosure is to provide an air blower and a static pressure evaluation apparatus that are configured to, during installation of a ventilation fan, provide information for improving a duct shape and a duct path by evaluating a duct resistance from a static pressure in a duct connected to the ventilation fan.

In order to achieve this object, an air blower according to one aspect of the present disclosure includes a brushless DC motor, a current detector, a rotation speed detector, an airflow rate calculator, a speed controller, a storage, a static pressure calculator, and a static pressure display. The current detector is configured to detect a value of a current flowing through the brushless DC motor. The rotation speed detector is configured to detect a rotation speed of the brushless DC motor. The airflow rate calculator is configured to calculate a currently outputted airflow rate from the value of the current detected by the current detector and the rotation speed detected by the rotation speed detector, and output a target rotation speed of the motor to bring the calculated airflow rate closer to a target airflow rate. The speed controller is configured to control the rotation speed of the brushless DC motor to the target rotation speed outputted by the airflow rate calculator. The storage is configured to store static pressures, values of currents, and rotation speeds at airflow rates in association with each other. The static pressure calculator is configured to calculate and output a current static pressure as a calculated static pressure, based on the value of the current detected by the current detector at a point in time when the calculated airflow rate reaches the target airflow rate, the rotation speed detected by the rotation speed detector at the point in time when the calculated airflow rate reaches the target airflow rate, the target airflow rate, and the storage. The static pressure display is configured to display the calculated static pressure outputted from the static pressure calculator.

A static pressure evaluation apparatus according to one aspect of the present disclosure is configured to evaluate a static pressure in a duct connected to an air blower, and includes a storage, a receiver, a static pressure calculator, and a display. The storage is configured to store static pressures, values of currents, and rotation speeds at airflow rates in association with each other. The receiver is configured to, from the air blower, receive a value of a current detected by a current detector at a point in time when a calculated airflow rate reaches a target airflow rate, a rotation speed detected by a rotation speed detector at the point in time when the calculated airflow rate reaches the target airflow rate, and the target airflow rate. The static pressure calculator is configured to calculate and output a current static pressure as a calculated static pressure, based on the value of the current, the rotation speed, and the target airflow rate that are received by the receiver, and the storage. The display is configured to display the calculated static pressure outputted from the static pressure calculator.

According to the present disclosure, information for improving a duct shape and a duct path can be provided, whereby a static pressure environment suitable for constant airflow rate control can be established, and as a result, an air blower and a static pressure evaluation apparatus that are capable of reducing energy consumption of a ventilation fan can be provided.

### BRIEF DESCRIPTION OF DRAWINGS

FIG. 1 is a schematic diagram of a ventilation fan according to Embodiment 1 of the present disclosure.

FIG. 2 is a functional block diagram of a control circuit and a static pressure evaluation circuit of the ventilation fan according to Embodiment 1 of the present disclosure.

FIG. 3 is a schematic diagram illustrating a display example of a static pressure in the ventilation fan according to Embodiment 1 of the present disclosure.

FIG. 4 is a functional block diagram of a control circuit of a ventilation fan and a static pressure evaluation circuit of a static pressure evaluation apparatus according to Embodiment 2 of the present disclosure.

FIG. 5 is a schematic diagram illustrating an example of the static pressure evaluation apparatus according to Embodiment 2 of the present disclosure.

FIG. 6 is a functional block diagram of a control circuit and a static pressure evaluation circuit of a ventilation fan and a static pressure evaluation apparatus according to Embodiment 3 of the present disclosure.

### DETAILED DESCRIPTION

Hereinafter, embodiments of the present disclosure will be described with reference to the attached drawings. Note that any of the embodiments described below represents a preferred specific example of the present disclosure. Therefore, numerical values, shapes, materials, constituents, arrangement positions and connection of the constituents, and steps and the order of the steps, each being described in the following embodiments, are merely exemplary and are not intended to limit the present disclosure. Hence, of the constituents in the following embodiments, constituents not set forth in independent claims which represent the most superordinate concept of the present disclosure are to be construed as optional constituents. Furthermore, in the drawings, substantially identical constituents are assigned the same reference signs, and overlapped descriptions thereof are omitted or simplified.

### Embodiment 1

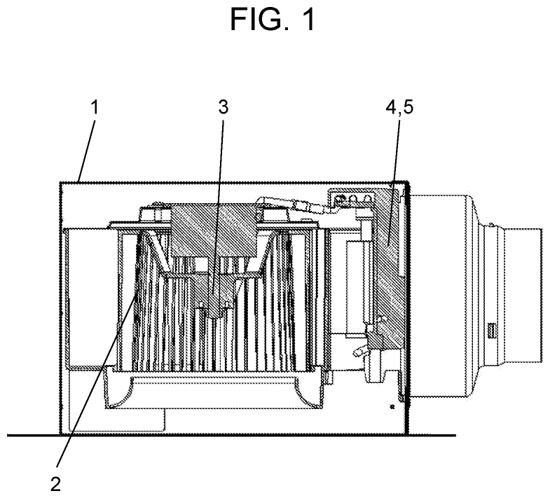

The outline structure of a ventilation fan as an embodiment of the air blower of the present disclosure will be described using FIG. 1. Note that FIG. 1 is a schematic diagram of ventilation fan 1 according to Embodiment 1.

Ventilation fan 1 is installed, for example, in a ceiling inside a building, and used for discharging air in the interior of the building to the exterior thereof. Ventilation fan 1 includes fan 2, brushless DC motor 3, control circuit 4, and static pressure evaluation circuit 5.

Fan 2 is, for example, a sirocco fan, and configured to rotate on a rotating shaft to inhale air from the lower side in FIG. 1 and blow off air from a side (the right-hand side in FIG. 1).

Brushless DC motor 3 has a shaft center fixed to the rotating shaft of fan 2, and is configured to rotate fan 2 by the rotation of the shaft center by electric supply and thereby blow air.

Control circuit 4 is connected to brushless DC motor 3 and configured to control, for example, the rotation speed of brushless DC motor 3. Control circuit 4 is configured to perform constant airflow rate control for brushless DC motor 3 and fan 2, and details of the constant airflow rate control will be described later.

Static pressure evaluation circuit 5 is configured to evaluate a static pressure obtained by calculating a static pressure in a duct connected to ventilation fan 1, and details of the evaluation will be described later.

Note that each of control circuit 4 and static pressure evaluation circuit 5 has a computer including a processor and a memory. Then, when each of the processors executes a computer program stored in a corresponding one of the memories, so that a computer system functions as control circuit 4 or static pressure evaluation circuit 5. Herein, the computer program executed by the processor is recorded in advance on the memory of the computer system, but may be provided with being recorded on a non-temporary recording medium, such as a memory card, or may be provided through telecommunication lines, such as the Internet.

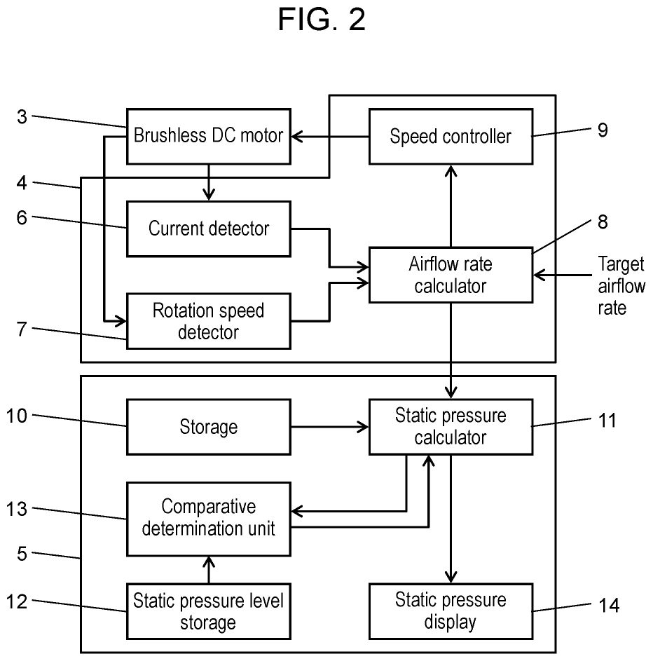

Subsequently, configurations of control circuit 4 and static pressure evaluation circuit 5 will be described using FIG. 2. Note that FIG. 2 is a functional block diagram of control circuit 4 and static pressure evaluation circuit 5 of ventilation fan 1.

Control circuit 4 includes current detector 6, rotation speed detector 7, airflow rate calculator 8, and speed controller 9.

Current detector 6 is configured to detect a current flowing through a winding of brushless DC motor 3 by making use of, for example, a shunt resistance, and output a value of the detected current to airflow rate calculator 8.

Rotation speed detector 7 is configured to detect a rotation speed of brushless DC motor 3 by using, for example, a sensor for detecting a position of a rotor, and output the detected rotation speed to airflow rate calculator 8.

Airflow rate calculator 8 is configured to calculate a target rotation speed of brushless DC motor 3 so that an output airflow rate of ventilation fan 1 becomes equivalent to an inputted target airflow rate, and output the target rotation speed to speed controller 9. At this time, airflow rate calculator 8 compares values of data on relations between values of currents and rotation speeds at airflow rates, the data having been stored in advance in airflow rate calculator 8, with the value of the current and the rotation speed respectively outputted from current detector 6 and rotation speed detector 7, and outputs a target rotation speed that acts to make differences in the values of the currents and the rotation speeds smaller. Furthermore, airflow rate calculator 8 is configured to output, to later-mentioned static pressure calculator 11, a value of a current, a rotation speed, and a value of the target airflow rate at a point in time when the present airflow rate is in agreement with the target airflow rate.

Speed controller 9 is configured to perform the speed control of rotation of brushless DC motor 3 by calculating and outputting a voltage to be applied to brushless DC motor 3 so that a rotation speed of brushless DC motor 3 becomes in agreement with the target rotation speed outputted by airflow rate calculator 8.

With these configurations, control circuit 4 performs constant airflow rate control for ventilation fan 1. Note that, as a parameter to be used for calculation in airflow rate calculator 8 or a parameter to be outputted to brushless DC motor 3 by speed controller 9, percent modulation of the voltage of the motor is sometimes used, but any of them may be adopted (reference: Japanese Unexamined Patent Application Publication No. 2015-028301).

Static pressure evaluation circuit 5 includes storage 10, static pressure calculator 11, static pressure level storage 12, comparative determination unit 13, and static pressure display 14.

Storage 10 is configured to store relation data describing a correlation between a value of a current flowing into brushless DC motor 3 of ventilation fan 1 operated at a certain airflow rate and a rotation speed of brushless DC motor 3 and the present static pressure value. Examples of the relation data include an approximate expression indicating relations among static pressures, values of currents, and rotation speeds at airflow rates, and a plurality of combinations of these values.

Static pressure calculator 11 is configured to compare a value of a current detected by current detector 6 at a point in time when a calculated airflow rate reaches the target airflow rate, a rotation speed detected by rotation speed detector 7 at the above-mentioned point in time, and the target airflow rate with the relation data stored in storage 10, and thereby calculate a value of a static pressure in the duct connected to ventilation fan 1, and output the value of the static pressure as a calculated static pressure. Furthermore, static pressure calculator 11 is further configured to output an evaluation outputted by comparative determination unit 13 to static pressure display 14.

Static pressure level storage 12 is configured to classify static pressure levels in the duct connected to ventilation fan 1 into two or more stages, and store evaluations in accordance with the stages of the static pressure levels. The evaluations include at least one of “normality evaluation” indicating that a static pressure allows constant airflow rate control, and “abnormality evaluation” indicating that a static pressure is too high to allow constant airflow rate control. The evaluations may be classified into arbitrary stages. For example, static pressure levels may be classified into level 1, level 2, level 3, and level 4, and level 4 may be defined as the abnormality evaluation.

Comparative determination unit 13 is configured to compare the calculated static pressure outputted by static pressure calculator 11 with varying stages of static pressure levels stored in static pressure level storage 12, and return, to static pressure calculator 11, an evaluation of a static pressure level corresponding to the calculated static pressure. Alternatively, comparative determination unit 13 may be configured to output the above-mentioned evaluation directly to static pressure display 14.

Static pressure display 14 is configured to display at least one of a value of the calculated static pressure outputted by the static pressure calculator and the evaluation.

Note that, as the relation data used by airflow rate calculator 8 and the relation data used by static pressure calculator 11, the relation data stored in storage 10 may be shared.

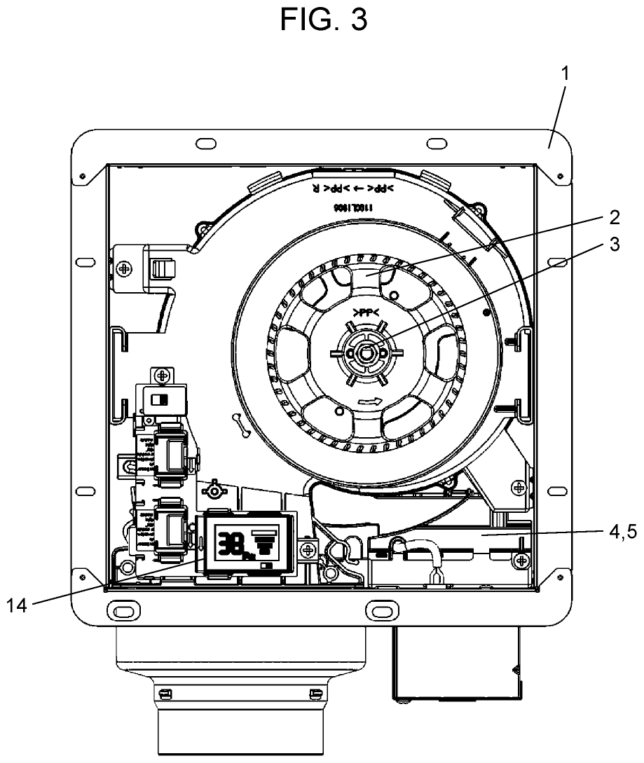

FIG. 3 is a schematic diagram illustrating a display example of a static pressure in ventilation fan 1 according to Embodiment 1. After a worker installs ventilation fan 1, ventilation fan 1 is operated in a manner similar to an actual use condition, whereby ventilation fan 1 displays a static pressure on static pressure display 14, as illustrated in FIG. 3. With this configuration, the worker improves, for example, a duct path with reference to the value of the static pressure or the evaluation of the static pressure on static pressure display 14, so that duct resistance to ventilation fan 1 is reduced, and an installation abnormality is improved, and energy efficient operation is realized.

At an actual installation site for the ventilation fan, different workers have different skills, and therefore, only with a display of a static pressure value, it is sometimes difficult for a worker to determine the presence of an abnormality from the value.

Therefore, besides a value of a static pressure, an evaluation obtained in accordance with the classification of static pressure values into levels is also displayed, whereby a static pressure state for ventilation fan 1 can be intuitively understood. As a result, a worker is informed of an abnormality in the value of the static pressure in the duct connected to ventilation fan 1, and, for example, a measure for reducing duct resistance, for example, improvement in a duct path, can be induced, and power consumption of ventilation fan 1 can be reduced.

At this time, if an abnormality evaluation is given, the detection of an abnormality can be more easily made also by implementing a scheme, such as a warning by sound.

In the case where a value of a static pressure is estimated in advance, a worker can easily check whether ventilation fan 1 has been appropriately installed, by evaluating whether a static value is in agreement with the beforehand estimated value.

### Embodiment 2

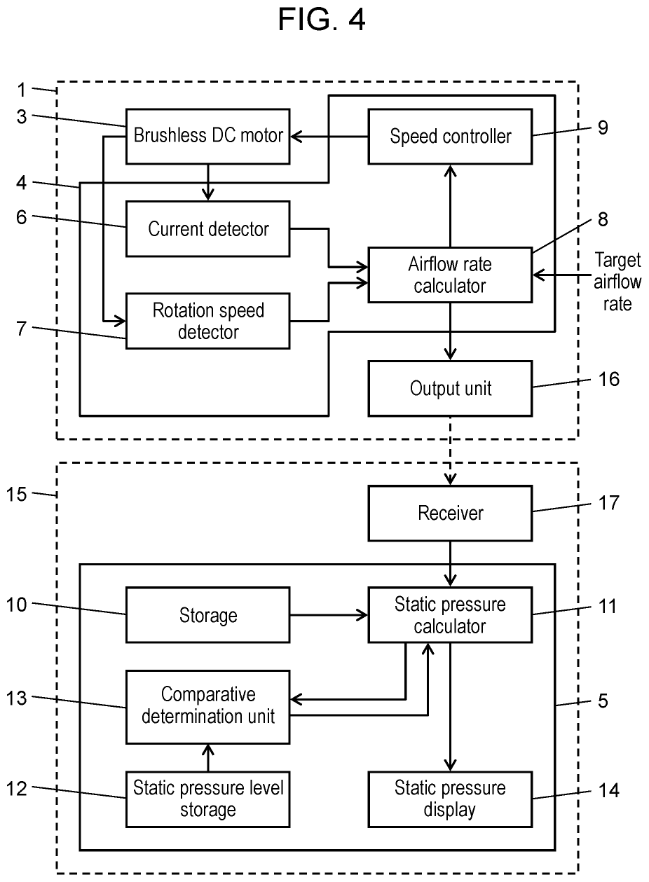

In the present embodiment, a configuration in which static pressure evaluation circuit 5 is removable from ventilation fan 1 described in Embodiment 1 will be described with reference to FIG. 4. Note that FIG. 4 is a functional block diagram of control circuit 4 of ventilation fan 1 and static pressure evaluation circuit 5 of static pressure evaluation apparatus 15.

As illustrated in FIG. 4, static pressure evaluation circuit 5 configured to calculate and evaluate a static pressure can be used as static pressure evaluation apparatus 15 independent of and connectable to the ventilation fan 1.

Here, a configuration different from that of Embodiment 1 is described.

Output unit 16 is configured to output, to static pressure evaluation apparatus 15, a value of a current detected by current detector 6 at a point in time when a calculated airflow rate outputted from airflow rate calculator 8 reaches a target airflow rate, a rotation speed detected by rotation speed detector 7 at the above-mentioned point in time, and the target airflow rate.

Receiver 17 is configured to receive the value of the current, the rotation speed, and the target airflow rate that are outputted by output unit 16, and output these values to static pressure calculator 11.

Static pressure display 14 is configured to display at least one of; a value of the calculated static pressure calculated and outputted by static pressure calculator 11 from the values received by the receiver 17 in the same manner as in static pressure evaluation circuit 5; and an evaluation of the value of the calculated static pressure.

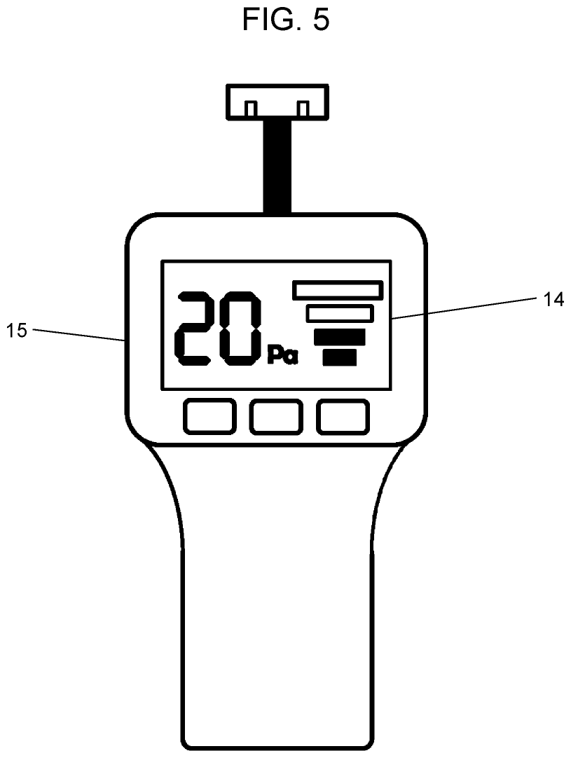

FIG. 5 is a schematic diagram illustrating an example of static pressure evaluation apparatus 15. Basically, evaluation of a static pressure is performed during installation only, and therefore, by making static pressure evaluation apparatus 15 independent of ventilation fan 1, manufacture costs of the ventilation fan itself can be further reduced, compared with a case in which static pressure evaluation circuit 5 is built in the ventilation fan.

Furthermore, by storing relation data on a plurality of models of ventilation fans in static pressure evaluation apparatus 15, static pressures of all the ventilation fans supported by one static pressure evaluation apparatus can be evaluated. In this case, static pressure evaluation apparatus 15 has the function of selecting a ventilation fan model, and, with this function, can switch to a target ventilation fan.

### Embodiment 3

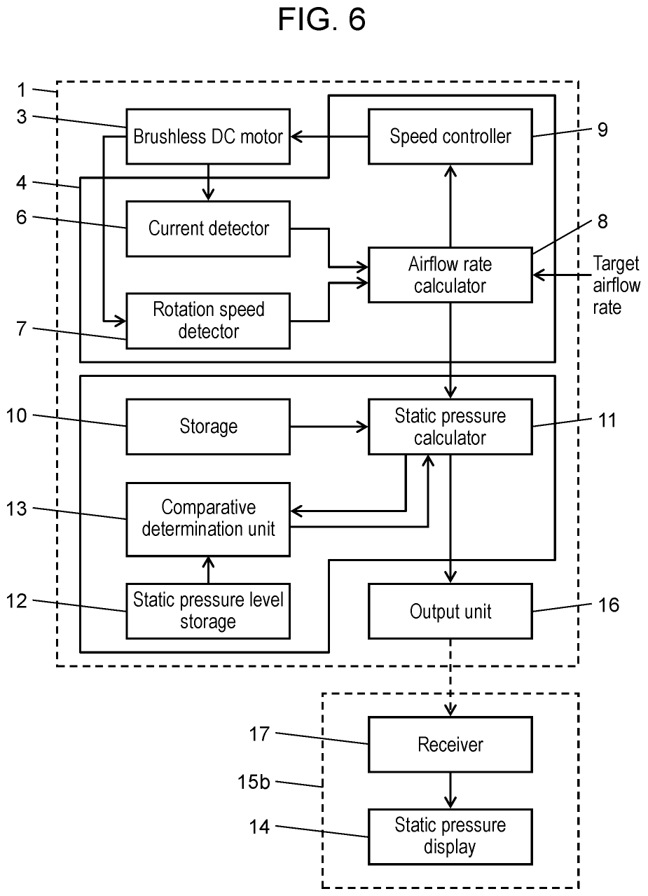

In the present embodiment, a configuration in which only static pressure display 14 is removable as static pressure evaluation apparatus 15b from ventilation fan 1 described in Embodiment 1 will be described with reference to FIG. 6. Note that FIG. 6 is a functional block diagram of control circuit 4 and static pressure evaluation circuit 5 of ventilation fan 1 and static pressure evaluation apparatus 15b.

As illustrated in FIG. 6, static pressure display 14 configured to display a value of a calculated static pressure and an evaluation thereof can be used as static pressure evaluation apparatus 15b independent of and connectable to ventilation fan 1.

Output unit 16 of ventilation fan 1 is configured to output, to static pressure evaluation apparatus 15b, a calculated static pressure calculated and outputted by static pressure evaluation circuit 5 and an evaluation of the value of the static pressure.

Static pressure evaluation apparatus 15b includes receiver 17 and static pressure display 14.

Receiver 17 is configured to receive the value of the static pressure and the evaluation of the static pressure that are outputted by output unit 16 and output the value and the evaluation to static pressure display 14.

Static pressure display 14 is configured to display at least one of the value of the calculated static pressure and the evaluation that are outputted by receiver 17.

In Embodiment 3, the function of displaying a value of a static pressure and an evaluation thereof, which are not required other than mainly at the time of installation, is removable, and as a result, compared with Embodiment 1 in which ventilation fan 1 includes static pressure display 14, manufacture costs of ventilation fan 1 can be further reduced while the same effect to be achieved as in Embodiment 1 is kept.

(Modifications)

In Embodiments 2 and 3, input and output of data between the ventilation fan and the static pressure evaluation apparatus are performed in a state that the ventilation fan and the static pressure evaluation apparatus are physically connected to each other. In the case of the physical connection, the static pressure evaluation apparatus is configured to be connected and fixed to the ventilation fan, so that a worker can check an evaluation of a static pressure with handsfree operation. However, the physical connection can be changed to wireless connection.

Wireless connection allows a worker to check an evaluation of a static pressure while working, for example, in a ceiling space, and allows the worker to set a duct path while operating the ventilation fan and checking a value of a static pressure and an evaluation thereof in real time. In this case, if a plurality of ventilation fans is provided, there is a risk of occurrence of communication interference, and therefore, a measure is desirably taken, for example, such that a data output switch or the like is provided on the side of a ventilation fan and the ventilation fan outputs data only when the switch is ON.

In FIG. 5, as a static pressure evaluation apparatus, a special-purpose apparatus designed to be used only for static pressure evaluation is assumed, but, without using the above-mentioned special-purpose apparatus, for example, as long as the above-mentioned functions of the static pressure evaluation apparatus are given to an application such as a cell phone handset, a manufacturer does not need to newly produce hardware, so that time and effort and cost can be reduced. Also, without the addition of a new device, a worker can easily update, for example, data stored in a storage when a new model is added, and thus can more easily use the apparatus.

### INDUSTRIAL APPLICABILITY

The air blower according to the present disclosure is widely useful in products such as a ceiling-embedded ventilation fan in which a static pressure in a duct connected to the air blower becomes large.

### REFERENCE MARKS IN THE DRAWINGS

1 . . . ventilation fan

2 . . . fan

3 . . . brushless DC motor

4 . . . control circuit

5 . . . static pressure evaluation circuit

6 . . . current detector

7 . . . rotation speed detector

8 . . . airflow rate calculator

9 . . . speed controller

10 . . . storage

11 . . . static pressure calculator

12 . . . static pressure level storage

13 . . . comparative determination unit

14 . . . static pressure display

15, 15b . . . static pressure evaluation apparatus

16 . . . output unit

17 . . . receiver

What is claimed is:

1. An air blower, comprising:
a brushless DC motor;
a current detector configured to detect a value of a current flowing through the brushless DC motor;
a rotation speed detector configured to detect a rotation speed of the brushless DC motor;
an airflow rate calculator configured to
calculate a currently-outputted airflow rate as a calculated airflow rate from the value of the current detected by the current detector and the rotation speed detected by the rotation speed detector, and
output a target rotation speed of the brushless DC motor to bring the calculated airflow rate closer to a target airflow rate;
a speed controller configured to control the rotation speed of the brushless DC motor to the target rotation speed outputted by the airflow rate calculator; and
a storage configured to store a static pressure, the value of the current, and the rotation speed at an airflow rate in association with each other;
a static pressure calculator configured to calculate and output a current static pressure as a calculated static pressure, based on the value of the current detected by the current detector at a point in time when the calculated airflow rate reaches the target airflow rate, the rotation speed detected by the rotation speed detector at the point in time when the calculated airflow rate reaches the target airflow rate, the target airflow rate, and the storage; and
a static pressure display configured to display the calculated static pressure outputted from the static pressure calculator.

2. The air blower according to claim 1,
wherein the airflow rate calculator exercises constant airflow rate control, the air flow rate control is a control that brings the calculated airflow rate closer to the target airflow rate, and
wherein the storage stores relation data establishing an association among the target airflow rate in the constant airflow rate control, a static pressure, the value of the current, and the rotation speed.

3. The air blower according to claim 2,
wherein the storage stores, as the relation data, an approximate expression that approximately expresses a relation among the target airflow rate, the static pressure, the value of the current, and the rotation speed,
the target airflow rate, the static pressure, the value of the current, and the rotation speed constituting the relation data, and
wherein the static pressure calculator calculates and outputs the calculated static pressure, based on the approximate expression, the target airflow rate, the value of the current, and the rotation speed.

4. The air blower according to claim 1, further comprising:
a static pressure level storage configured to classify evaluations in accordance with static pressure levels into a plurality of stages and store the evaluations; and
a comparative determination unit configured to compare the calculated static pressure outputted by the static pressure calculator with the evaluations stored in the static pressure level storage, and output an evaluation, of the evaluations, to which the calculated static pressure outputted by the static pressure calculator belongs,
wherein, based on a result outputted by the comparative determination unit, the static pressure display displays the evaluation to which the calculated static pressure outputted by the static pressure calculator belongs.

5. The air blower according to claim 4,
wherein the evaluations include at least one of
a normality evaluation indicating that the calculated static pressure outputted by the static pressure calculator is normal, and
an abnormality evaluation indicating that the calculated static pressure outputted by the static pressure calculator is abnormal.

6. The air blower according to claim 1,
wherein the static pressure display displays a value of the calculated static pressure outputted from the static pressure calculator.

7. An air blower, comprising:
a brushless DC motor;
a current detector configured to detect a value of a current flowing through the brushless DC motor;
a rotation speed detector configured to detect a rotation speed of the brushless DC motor;
an airflow rate calculator configured to
calculate a currently-outputted airflow rate as a calculated airflow rate from the value of the current detected by the current detector and the rotation speed detected by the rotation speed detector, and
output a target rotation speed of the brushless DC motor to bring the calculated airflow rate closer to a target airflow rate;
a speed controller configured to control the rotation speed of the brushless DC motor to the target rotation speed outputted by the airflow rate calculator; and
an output unit configured to output, to a static pressure evaluation apparatus, the value of the current detected by the current detector at a point in time when the calculated airflow rate reaches the target airflow rate, the rotation speed detected by the rotation speed detector at the point in time when the calculated airflow rate reaches the target airflow rate, and the target airflow rate.

8. A static pressure evaluation apparatus configured to evaluate a static pressure in a duct connected to an air blower, the static pressure evaluation apparatus comprising:
a storage configured to store the static pressure, a value of a current, and a rotation speed at an airflow rate in association with each other;
a receiver configured to receive, from the air blower, the value of the current detected by a current detector at a point in time when a calculated airflow rate reaches a target airflow rate, the rotation speed detected by a rotation speed detector at the point in time when the calculated airflow rate reaches the target airflow rate, and the target airflow rate;
a static pressure calculator configured to calculate and output a current static pressure as a calculated static pressure, based on the value of the current, the rotation speed, the target airflow rate, and the storage,
the value of the current, the rotation speed, the target airflow rate being received by the receiver; and
a static pressure display configured to display the calculated static pressure outputted from the static pressure calculator.

9. An air blower, comprising:
a brushless DC motor;
a current detector configured to detect a value of a current flowing through the brushless DC motor;
a rotation speed detector configured to detect a rotation speed of the brushless DC motor;
an airflow rate calculator configured to
calculate a currently-outputted airflow rate as a calculated airflow rate from the value of the current detected by the current detector and the rotation speed detected by the rotation speed detector, and
output a target rotation speed of the brushless DC motor to bring the calculated airflow rate closer to a target airflow rate;
a speed controller configured to control the rotation speed of the brushless DC motor to the target rotation speed outputted by the airflow rate calculator;
a storage configured to store a static pressure, the value of the current, and the rotation speed at an airflow rate in association with each other;
a static pressure calculator configured to calculate and output a current static pressure as a calculated static pressure, based on the value of the current detected by the current detector at a point in time when the calculated airflow rate reaches the target airflow rate, the rotation speed detected by the rotation speed detector at the point in time when the calculated airflow rate reaches the target airflow rate, the target airflow rate, and the storage; and
an output unit configured to output, to a static pressure evaluation apparatus, the calculated static pressure outputted by the static pressure calculator.

10. A static pressure evaluation apparatus configured to evaluate a static pressure in a duct connected to an air blower, the static pressure evaluation apparatus comprising:
a receiver configured to receive a calculated static pressure from the air blower; and
a static pressure display configured to display the calculated static pressure outputted from a static pressure calculator.
